(19) United States
(12) Patent Application Publication
(10) Pub. No.: US 2022/0123464 A1
(43) Pub. Date: Apr. 21, 2022

(54) SYSTEMS AND DEVICES FOR MUTUAL DIRECTIVE BEAM SWITCH ARRAY

(71) Applicant: SONY GROUP CORPORATION, Tokyo (JP)

(72) Inventors: Zhinong YING, Lund (SE); Kun ZHAO, Malmö (SE)

(21) Appl. No.: 17/420,816

(22) PCT Filed: Feb. 6, 2019
(86) PCT No.: PCT/US2019/016754

§ 371 Date: Jul. 6, 2021

(51) Int. Cl. H01Q 3/24; H01Q 21/24; H01Q 21/22

(52) U.S. Cl. CPC H01Q 3/24; H01Q 21/22; H01Q 21/24

(57) ABSTRACT

An antenna module for beam steering at mm Wave frequencies is described. The antenna module includes a plurality of antenna elements. The antenna module is configured to selectively activate a first antenna element of the plurality of antenna elements, while remaining ones of the plurality of antenna elements are passive, for beam steering in a first direction. The antenna module is further configured to selectively activate a second antenna element of the plurality of antenna elements, while the remaining ones of the plurality of antenna elements and the first antenna element are passive, for beam steering in a second direction. The first antenna element and the second antenna element are respectively configured to resonate at a resonant frequency when activated. Related systems and devices are also described.

### FIELD

Various embodiments described herein relate to an antenna system.

### BACKGROUND

In 5G New Radio (NR) networks, communication may occur between a base station, e.g., gNB, and a wireless electronic device, such as a user equipment (UE). Various types of antennas may be used for the communication between the base station and user equipment. Higher frequency bands such as mm Wave or 10 GHz to 100 GHz frequencies have very small wavelengths, which may cause challenges related to antenna size and/or antenna performance. In the 3GPP TS38.101-2 standards, the mobile handset is specified to meet certain levels of spherical coverage. The requirement on beam steering capability of the 5G UE is defined as spherical coverage in 3GPP, where the spherical coverage indicates the solid angular region that the UE may cover with its beams. A larger beam steering angle that an array antenna achieves provides larger spherical coverage that the array antenna may provide. The uplink spherical coverage of UEs may be measured by the cumulative distribution function (CDF) of the effective (or equivalent) isotropic radiated power (EIRP). For handheld UEs (power class 3 in 3GPP), the EIRP at the 50th percentile of the distribution of radiated power measured over the full sphere around the UE should not be lower than 11.5 dBm for band n257, n258, n261 in 3GPP TS38.101-02, and 8 dBm for band n260).

### SUMMARY

Conventional mm Wave systems may use antennas with feed networks, phase shifters, and/or microstrip feed lines that have higher than desired insertion losses, antenna size, and reduced bandwidth.

Various embodiments described herein provide an antenna system with compact size for use in mobile devices, control of the switching impedance and control of the electromagnetic field coupling to scatter the antenna beams to realize a high efficiency switched beam forming system. More specifically, reducing insertion losses caused by, for example, a feed network and/or microstrip feed lines provide a higher efficiency directive beam switch array antenna. The higher performance antenna is achieved by using an antenna with dual polarization using antenna elements placed in closer proximity to one another than conventional antenna designs, reducing the need for an external feeding network. Removing the external feeding network and/or removing microstrip feed lines reduces insertion losses of the antenna. In other words, various embodiments described herein provide a beam forming antenna system with wider bandwidth due to lower insertion losses and a smaller array antenna module footprint than conventional antennas.

Various embodiments of the present inventive concepts include an antenna module for beam steering at mm Wave frequencies. The antenna module includes a plurality of antenna elements. The antenna module is configured to selectively activate a first antenna element of the plurality of antenna elements, while remaining ones of the plurality of antenna elements are passive, for beam steering in a first direction. The antenna module is further configured to selectively activate a second antenna element of the plurality of antenna elements, while the remaining ones of the plurality of antenna elements and the first antenna element are passive, for beam steering in a second direction. The first antenna element and the second antenna element are respectively configured to resonate at a resonant frequency when activated.

In various embodiments, the antenna module may include an antenna switch that is configured to selectively activate the first antenna element, and the antenna switch may be further configured to selectively activate the second element. A distance between the first antenna element and an adjacent antenna element is less than 0.1 times a wavelength of the resonant frequency. A distance between adjacent edges of the antenna elements may be one-tenth to one-twentieth of the wavelength (λ/10 to λ/20). In some embodiments, the distance between the centers of the adjacent antenna elements may be a quarter wavelength (λ/4). The antenna switch may be configured to ground or impedance terminate the remaining ones of the plurality of antenna elements that are passive. The remaining ones of the plurality of antenna elements that are passive may be configured to determine a first direction of a first antenna beam radiating from the first antenna element. The first direction of the first antenna beam radiating from the first antenna element may be controlled by a coupling level between the first antenna element and an adjacent antenna element.

In various embodiments, a second antenna element of the remaining ones of the plurality of antenna elements is activated and the first antenna element is deactivated, a second antenna beam radiating from the second antenna element is generated. The second antenna beam may radiate in a second direction that is different from the first direction of the first antenna beam. The antenna module may be absent of a feed network, a phase shifter, and a microstrip line to control a radiation pattern associated with the plurality of antenna elements. Ones of the plurality of antenna elements are a length of approximately 0.5 times a wavelength of the resonant frequency. The plurality of antenna elements may include four antenna elements that are arranged in a 2×2 array. The plurality of antenna elements may include four antenna elements that are arranged in a 1×4 linear array. The antenna switch may be configured to provide impedance loading to the first antenna element that is active. The antenna switch may be configured to either ground or provide impedance loading to the remaining ones of the plurality of antenna elements that are configured to be passive to control a first direction of a first antenna beam radiating from the first antenna element.

In various embodiments, the first antenna element may include a first port and a second port that are configured to activate the first antenna element. The first antenna element may be configured to resonate at a first polarization when the first port is activated and may be configured to resonate at a second polarization when the second port is activated. The first polarization may be orthogonal to the second polarization. The first antenna element may resonate in a dual polarization configuration when both the first port and the second port are activated. The first antenna element may be configured to produce a first antenna beam in a first direction and with a first polarization when the first port is activated and the second port is deactivated, and may be configured to produce the first antenna beam in the first direction and with a second polarization when the second port is activated and the first port is deactivated, and may be configured to produce a third antenna beam in the first direction and with a third polarization when both the first port and the second port are activated, where the first, second, and third polarizations are different from one another. The remaining ones of the plurality of antenna elements may include respective first ports and respective second ports. The respective first ports and the respective second ports of the remaining ones of the plurality of antenna elements may be configured to be passive when the first port and/or the second port of the first antenna element are activate.

Various embodiments of the present inventive concepts include an antenna system. An antenna system may include an antenna module that includes a plurality of antenna elements and an antenna switch that is configured to selectively activate a first antenna element of the plurality of antenna elements, while remaining ones of the plurality of antenna elements are passive, for beam steering in a first direction. The antenna switch may be further configured to selectively activate a second antenna element of the plurality of antenna elements, while the remaining ones of the plurality of antenna elements and the first antenna element are passive, for beam steering in a second direction. The first antenna element and the second antenna element are respectively configured to resonate at a resonant frequency when activated.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF THE DRAWINGS

The accompanying drawings, which are included to provide a further understanding of the present disclosure and are incorporated in and constitute a part of this application, illustrate certain embodiment(s). In the drawings:

FIG. 1 illustrates an antenna that may be used in wireless communication systems, according to various embodiments of the present inventive concepts.

FIGS. 2A-2D illustrate the radiation patterns around a wireless electronic device such as a UE, including the antenna of FIG. 1, according to various embodiments of the present inventive concepts.

FIG. 3 illustrates an antenna that may be used in wireless communication systems, according to various embodiments of the present inventive concepts.

FIGS. 4A-4D illustrate the radiation patterns around a wireless electronic device such as a UE, including the antenna of FIG. 3, according to various embodiments of the present inventive concepts.

FIG. 5 graphically illustrates the frequency response of the antenna of FIG. 3, according to various embodiments of the present inventive concepts.

FIG. 6 illustrates a switch for the antenna of FIG. 3, according to various embodiments of the present inventive concepts.

FIG. 7 illustrates the radiation pattern around a wireless electronic device such as a UE, including the antenna of FIG. 3 and using the switch of FIG. 6, according to various embodiments of the present inventive concepts.

FIG. 8 graphically illustrates the frequency response of the antenna of FIG. 3, according to various embodiments of the present inventive concepts.

FIGS. 9A-9D illustrate the radiation patterns around a wireless electronic device, including the array antenna of FIG. 3 and using the switch of FIG. 6, according to various embodiments of the present inventive concepts.

FIGS. 10A, 10B, and 11 illustrate a planar patch array antenna, according to various embodiments of the present inventive concepts.

FIG. 12 illustrates a linear array antenna, according to various embodiments of the present inventive concepts.

FIGS. 13 and 14 illustrate antenna coupling, according to various embodiments of the present inventive concepts.

FIG. 15 illustrates a 1×4 linear array antenna, according to various embodiments of the present inventive concepts.

FIG. 16 illustrates a switch for the 1×4 linear array antenna of FIG. 15, according to various embodiments of the present inventive concepts.

FIGS. 17A, 18A, 19A, and 20A graphically illustrate the directivity of various patches of the 1×4 linear array antenna of FIG. 15, according to various embodiments of the present inventive concepts.

FIGS. 17B, 18B, 19B, and 20B illustrate the radiation pattern around a wireless electronic device, including the 1×4 linear array antenna of FIG. 15, according to various embodiments of the present inventive concepts.

FIG. 21 illustrates a dual port realization of an array antenna, according to various embodiments of the present inventive concepts.

FIG. 22 illustrates the radiation patterns around a wireless electronic device, including the dual port antenna of FIG. 21, according to various embodiments of the present inventive concepts.

FIG. 23 illustrates a switch for the dual port antenna of FIG. 22, according to various embodiments of the present inventive concepts.

FIG. 24 is a block diagram of wireless electronic devices, according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Communication in 5G New Radio (NR) networks may occur between a base station, e.g., gNB, and a wireless electronic device, also referred to as a user equipment (UE), using millimeter band radio frequencies. Millimeter band radio frequencies or mm Wave channels in the electromagnetic spectrum, for example, may operate from 10 GHz to 300 GHz. Various types of antennas may be used for the communication between the base station and the wireless electronic device. Antennas used in 5G mobile networks may include array antennas, such as patch array antennas, which may have a directive antenna radiation pattern. Patch antennas are desirable for mm Wave communication since patch antennas provide a directional radiation pattern, offer dual polar realizations, are compact in size, and may be placed on a surface of a PCB. Dual polar realizations in 5G mobile networks may be suitable for diversity and multiplexing in the mm Wave frequency ranges. Conventionally, phase shifters, butler matrices, and/or digital domain processing may be used for beam steering, but may introduce extra insertion losses, energy losses, and heating issues with the antenna arrangements. Typical legacy antenna systems may use half wavelength (λ/2) spacing between antenna elements, since λ/2 spacing is a maximum distance to avoid side lobes in the antenna beams. Shorter wavelengths and half wavelength (λ/2) spacing between antenna elements may cause coupling losses and thus may be undesirable in legacy antenna designs.

Various embodiments described herein may arise from the recognition that in mm Wave systems, an antenna with compact size, control of the switch impedance, and control of the electromagnetic field coupling to scatter the antenna beams may be needed to realize a high efficiency switched beam forming system. More specifically, reduction of insertion loss by the switch caused by a feed network may provide a higher efficiency directive beam switch array antenna. A suitable antenna may be realized using a dual polar antenna, such as a patch antenna, using passive antenna elements and active or in other words radiating antenna elements, without an external feeding network. In other words, removing the external feeding network from the antenna design may significantly reduce insertion losses experienced by the antenna. However, other ways of beam steering is then required. According to various embodiments described herein, an antenna system capable of dynamic steering of the beam is provided. Further aspects of the embodiments relate to achieving a wider bandwidth and a smaller footprint of the antenna module than what is possible with conventional antennas. The various inventive concepts of the array antenna will now be discussed in further detail.

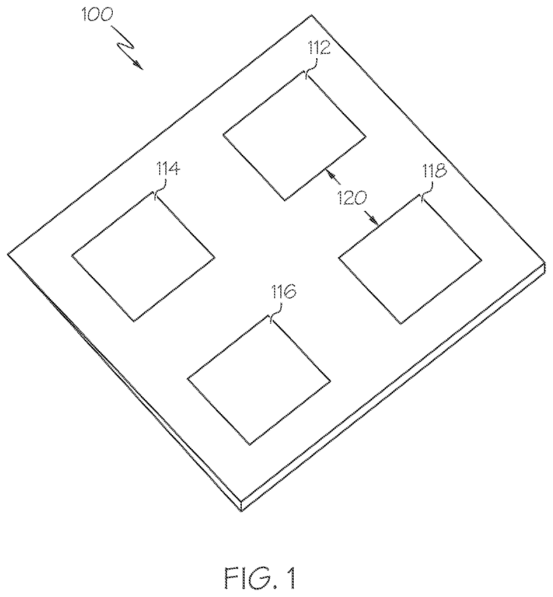

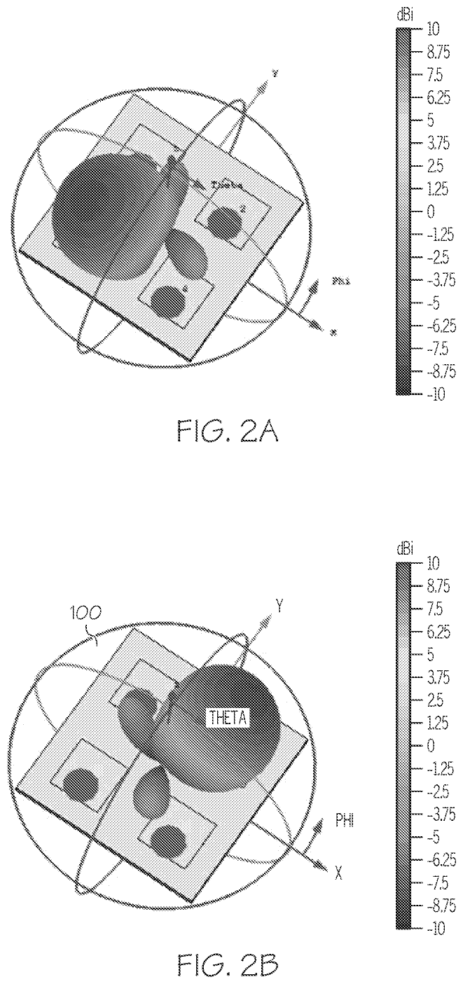

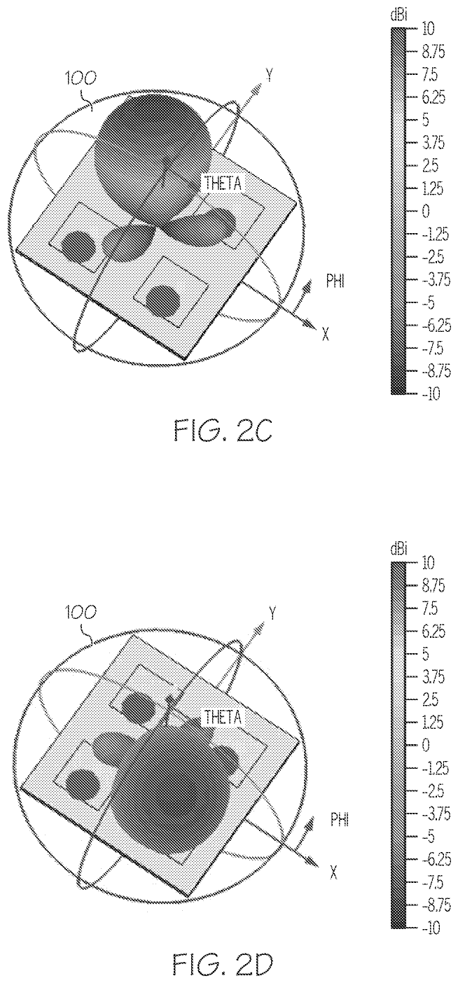

Beam steering of the radiation pattern from an array antenna is used for mm Wave antenna solutions. FIG. 1 illustrates a conventional array antenna that may be used in wireless communication systems. Referring to FIG. 1, antenna 100 is a 4-input/4-output feed network that includes antenna elements 112, 114, 116, and 118. Antenna elements 112, 114, 116, and 118 may be patches. The antenna elements may be spaced apart by a distance 120 such as, for example, half wavelength (λ/2). Antenna 100 may use a conventional phased array that can generate multiple beams. However, conventional phased arrays may suffer from a high loss due to phase shifters associated with the feed network that may produce large signal insertion losses. For example, 7 dB to 8 dB of insertion loss may occur at 28 GHz in some commercial phase shift components. Antenna 100 may use a beam switch array with a butler matrix feeding network such that insertion loss may be reduced to 1.5 dB at 28 GHz. FIGS. 2A-2D illustrate the radiation patterns around a wireless electronic device including the array antenna of FIG. 1. Referring to FIGS. 2A-2D, the radiation patterns of beams from antenna elements 114, 118, 112, and 116, respectively, are illustrated.

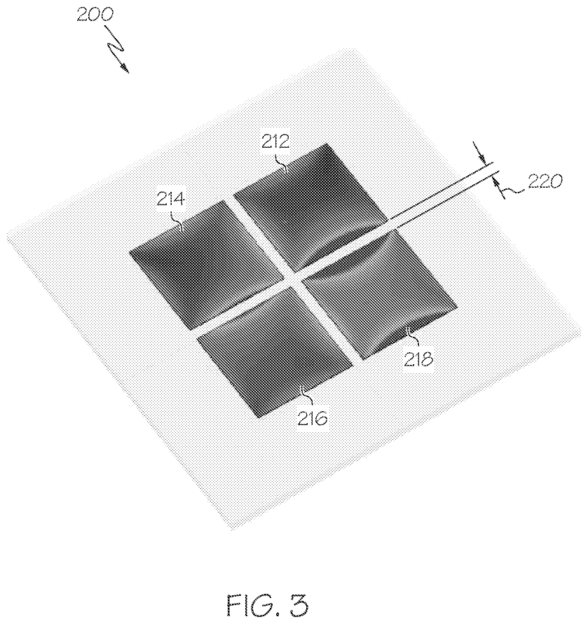

However, according to various embodiments of the inventive concepts, the feed network associated with the antenna 100 may be removed from the antenna design in order to further reduce insertion losses. FIG. 3 illustrates an array antenna that does not use a feed network. Antenna 200 includes antenna elements 212, 214, 216, and 218. Although antenna 200 is shown with the antenna elements arranged in a 2×2 array, various embodiments described herein apply to other array arrangements such as 3×3, 4×4, 2×4, 1×4, 1×5, 1×6, 1×8 etc. The antenna elements 212, 214, 216, and 218 are illustrated, for example, in FIG. 3 as being substantially parallel to one another. However, in various embodiments, the antenna elements 212, 214, 216, and 218 may be offset from one another, be angled towards one another, and/or have different sizing (i.e. length and/or width) than one another. Moreover, antenna elements 212, 214, 216, and 218 may be different shapes than rectangular patches, such as circular, triangular, trapezoidal, and/or with irregular edges. The antenna elements 212, 214, 216, and 218 are spaced apart by a distance 220 between adjacent edges of the antenna elements that may be one-tenth to one-twentieth of the wavelength (λ/10 to λ/20). In some embodiments, the distance between the centers of the adjacent antenna elements may be a quarter wavelength (λ/4). The antenna elements 212, 214, 216, and 218 themselves may be half wavelength (λ/2) in length and/or width. For an example patch antenna, the length of the patch and/or dipole may be about half wavelength (λ/2). For example pifa antennas or monopole antennas, the length of the antenna elements may be a quarter wavelength (λ/4). Antenna elements 212, 214, 216, and 218 may resonate at a resonant frequency of the antenna 200. The antenna elements 212, 214, 216, and 218, for example, may resonate at a same frequency as one another.

Although the antenna elements 212, 214, 216, and 218 of antenna 200 FIG. 3 appear to be co-planar, according to some embodiments, antenna elements 212, 214, 216, and/or 218 may be in different layers of a substrate that includes the antenna. For example, antenna element 212 may be in a first layer, but antenna elements 214, 216, and/or 218 may be in one or more other layers that are separate from the first layer. Furthermore, antenna elements that are in different layers may be directly over one another, overlapping one another, or non-overlapping with one another, in a plan view, in various embodiments.

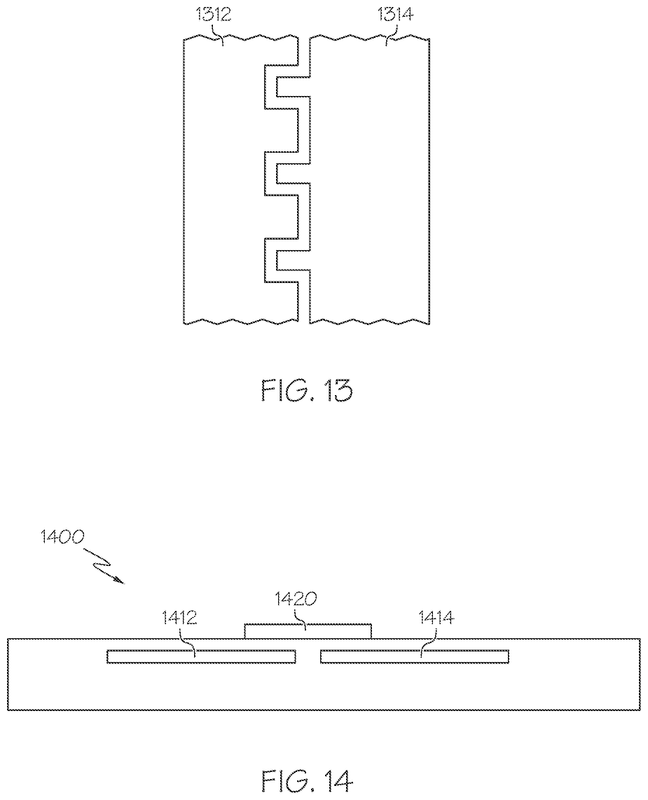

Reducing the spacing between antenna elements and removing the feed network provides a compact planar array antenna. By placing the antenna elements extremely close to each other, the passive elements can behave as a director for the active elements. In some embodiments, one of the four antenna elements may be “on” or “activate” at a time while the remaining antenna elements behave as passive antenna elements. The passive antenna elements may thus guide the beams and provide high directivity to the beam to tilt in a direction needed for communication with a base station or other device. In some embodiments, edges of the antenna elements 212, 214, 216, and 218 may not be straight, but may have a shape that increases the edge length, such as shown in FIG. 13.

Compared to a conventional planar array antenna of FIG. 1, the antenna 200 of FIG. 3 has reduced total area of the array antenna. There is not a need for the one or more phase shifters or butler matrices feeding this antenna network due to the close proximity of the antenna elements, thus reducing insertion loss. Additionally, conventional MIMO antennas may have multiple ports or antenna elements that are concurrently active, which is in contrast to dynamic switching to have one of the four antenna elements as active while the remaining antenna elements are passive. Additionally, conventional antennas may include multiple phase shifters, with a phase shifter that corresponds to each antenna element. According to various embodiments described herein, these multiple phase shifters are not needed.

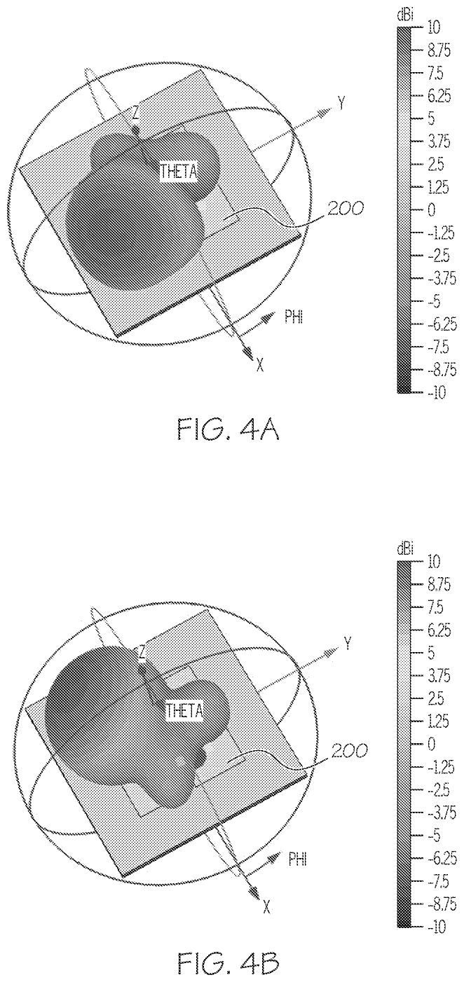

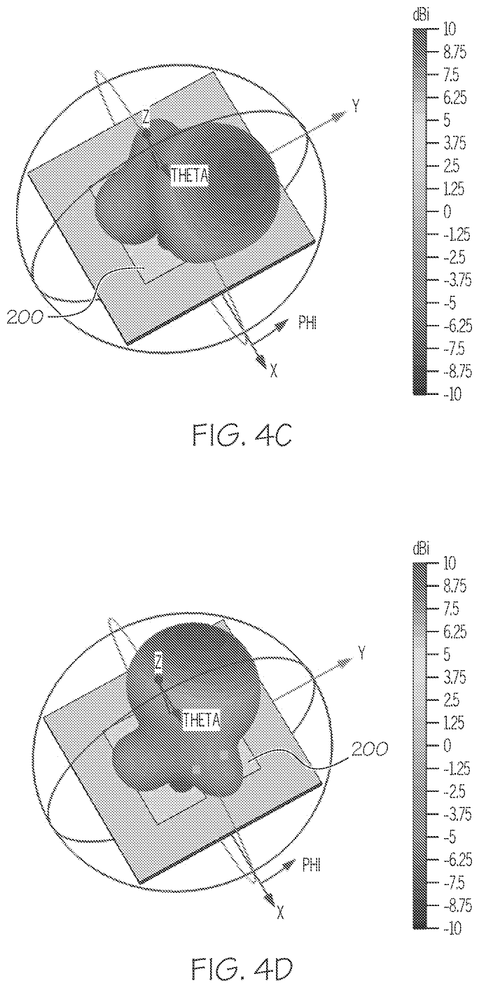

FIGS. 4A-4D illustrate the radiation patterns around a wireless electronic device including the array antenna of FIG. 3. Referring to FIGS. 4A-4D, the radiation patterns of beams from antenna elements 216, 214, 218, and 212, respectively, are illustrated. These radiation patterns are for the condition where one of the four antenna elements is “active” while the other three antenna elements are “passive”. Good directivity of the antenna beam with reduced insertion loss is obtained.

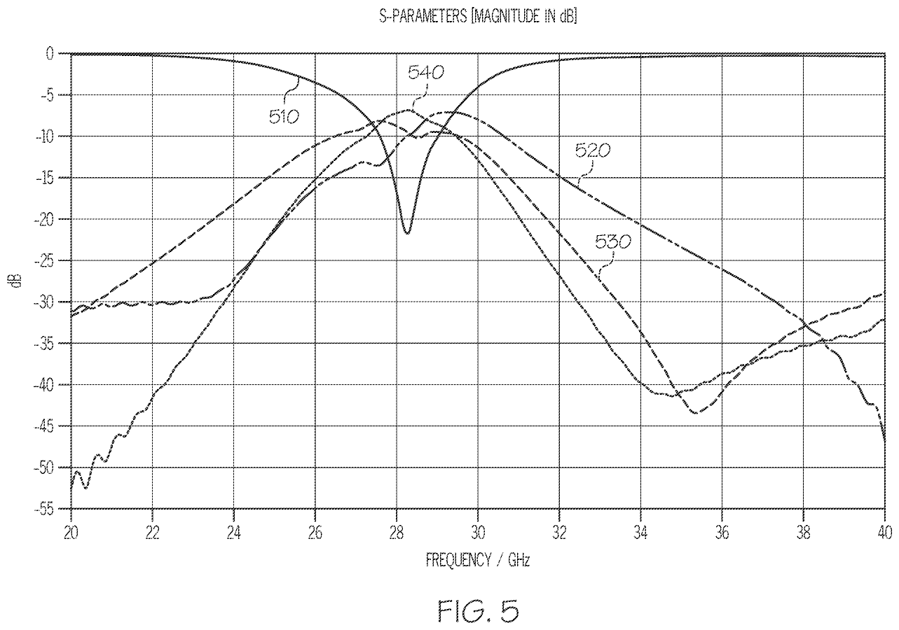

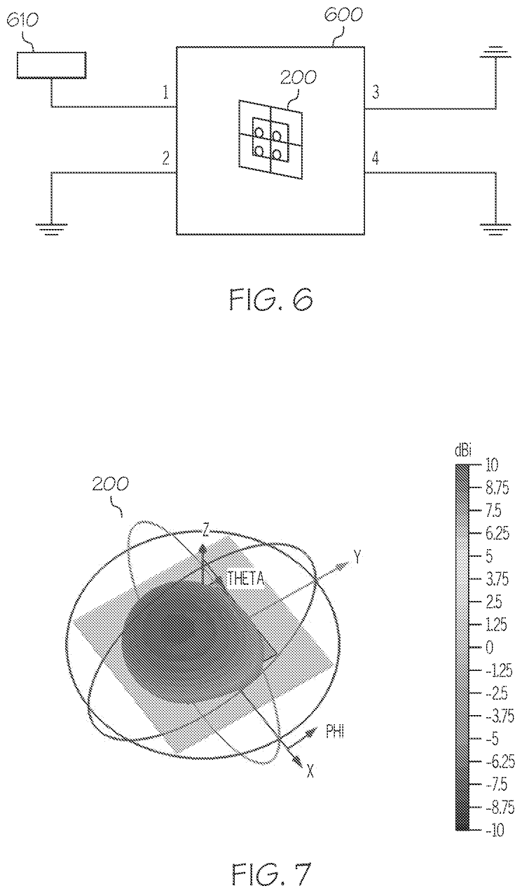

FIG. 5 graphically illustrates the frequency response of the array antenna of FIG. 3. The reflection coefficients for each of the antenna elements in relation to other antenna elements are provided. Referring to FIG. 5, improved bandwidth around 28 GHz is obtained for the array antenna of FIG. 3, as illustrated by curve 510, which is associated with the active antenna elements of the array antenna of FIG. 3. The passive elements act as a parasitic element and improve the overall bandwidth of the overall array antenna. However, due to the close spacing of the antenna elements, the mutual coupling between antenna ports may be high, as will be further explained with reference to FIG. 6. The mutual coupling between various antenna elements is illustrated by curves 520, 530, and 540.

FIG. 6 illustrates a switch for the antenna of FIG. 3. Switch 600 is configured to provide switching of various ports associated with the antenna elements of antenna 200 of FIG. 3. For example, antenna element 610, associated with port 1 of switch 600 may be active in this non-limiting example. Ports 2, 3, and 4 may be configured to be inactivated, i.e. make the antenna elements passive, by either grounding (i.e. short circuit) or providing a termination with impedance. If a termination with impedance is used with the passive antenna elements, then the value of the impedance may depend on the switch design and/or the radiation characteristics of the antenna elements of antenna 200. For example, an impedance of 50 ohms may be used with the passive antenna elements. Other values of the impedance may be used based on the array antenna design.

FIG. 7 illustrates the radiation pattern around a wireless electronic device such as a UE, including the antenna of FIG. 3 and using the switch of FIG. 6. Based on selectively controlling one antenna element to be active while remaining antenna elements are passive, the radiation pattern around antenna 200 may have improved beam steering features, increased bandwidth, and/or enhanced total efficiency by −3 dB to −0.7 dB, for example, for specific parameters used for the antenna with respect to FIG. 7.

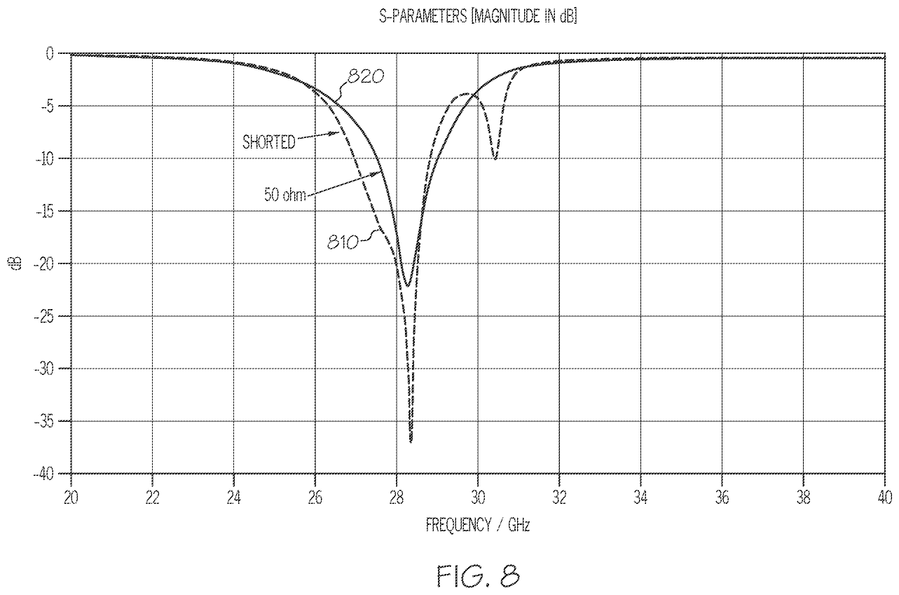

FIG. 8 graphically illustrates the frequency response of the antenna of FIG. 3. Referring to FIG. 8, short circuiting the passive elements of the antenna may produce the frequency response 810 whereas impedance termination of the passive elements of the antenna may produce the frequency response 820. In the example antenna with respect to FIGS. 7 and 8, short circuiting of the passive elements produced improved total efficiency, due to reduced port coupling loss.

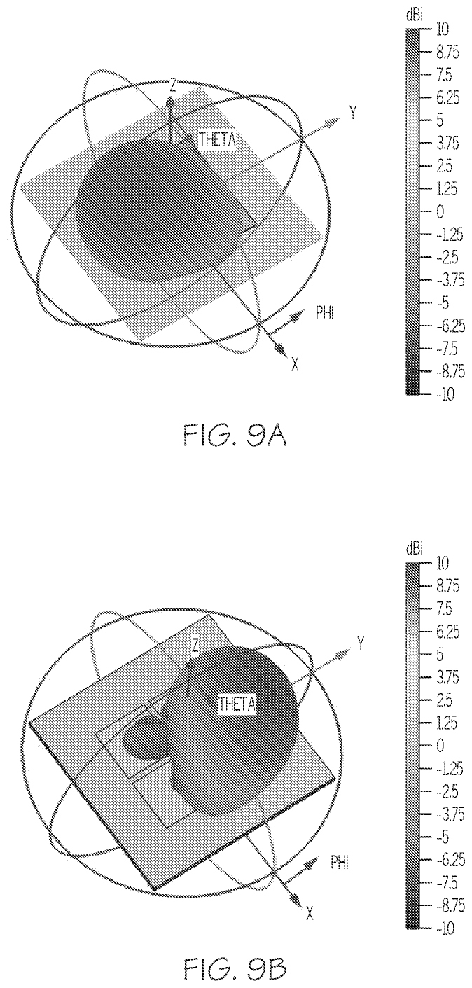

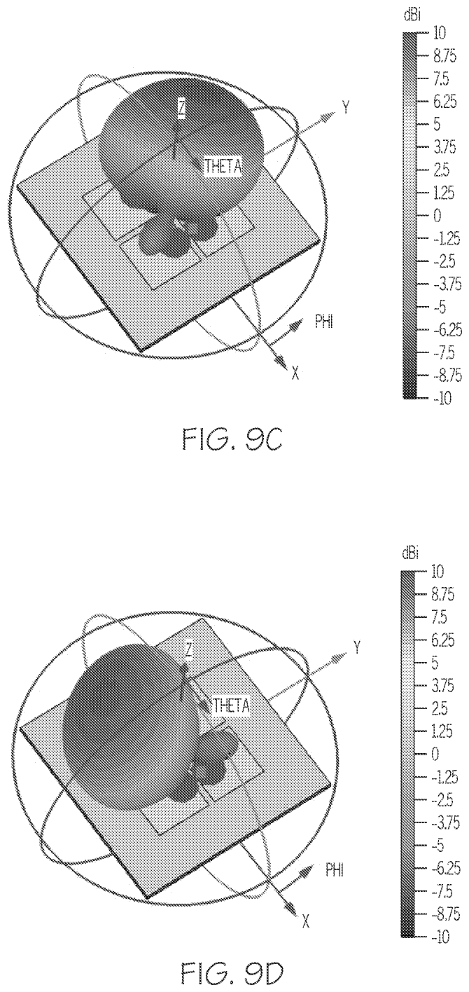

FIGS. 9A-9D illustrate the radiation patterns around a wireless electronic device, including the array antenna of FIG. 3 and using the switch of FIG. 6. Referring to FIGS. 9A-9D, the radiation patterns of beams from antenna elements 216, 218, 212, and 214, respectively, are illustrated. These radiation patterns are for the condition where one of the four antenna elements is active while the other three antenna elements are in passive mode and are shorted to ground, as illustrated in FIG. 6. Excellent beam directivity with very little insertion loss is obtained, as illustrated in FIGS. 9A-9D.

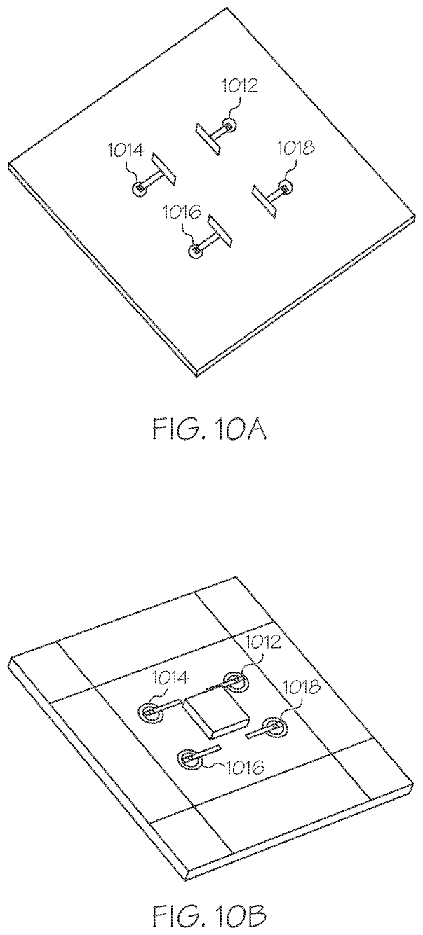

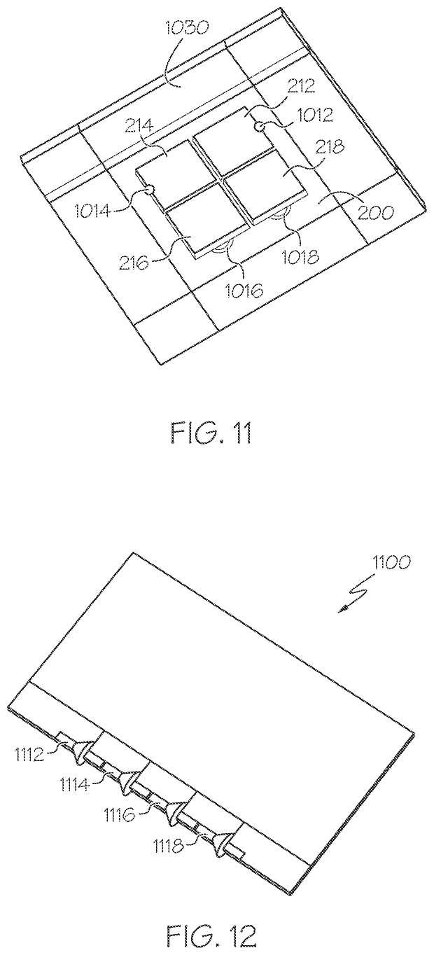

FIGS. 10A and 10B illustrate a planar array antenna switch. Referring to FIGS. 10A and 10B, the array antenna of FIG. 3, for example, may be directly connected to a SP4T switch, which is a single input, four output switch at ports 1012, 1014, 1016, and 1018. The planar array antenna and associated switch provides a compact footprint without a feeding network. FIG. 11 illustrates a planar array antenna with mushroom patches. Referring to FIG. 11, antenna 200 includes antenna elements 212, 214, 216, and 218 which are connected to switch ports 1012, 1014, 1016, and 1018, respectively. Meta material mushroom patches 1030 may be placed around antenna 200 to remove or reduce interference from other components in the wireless electronic device or in the environment. The smaller footprint of antenna 200, with close distances between the antenna elements 212, 214, 216, and 218 provides space for the mushroom patches 1030. Advantageously, the mushroom patches 1030 may be integrated more easily into a wireless electronic device such as a mobile device, thus providing improved performance due to reduce interference to the antenna 200.

FIG. 12 illustrates a linear array antenna. Referring to FIG. 12, linear array antenna 1100 includes antenna elements 1112, 1114, 1116, and 1118 arranged in a 1×4 array. Antenna elements 1112, 1114, 1116, and 1118 are placed in close proximity to one another, separated by an edge to edge distance such as, for example, one-tenth to one-twentieth of the wavelength (λ/10 to λ/20). In some example embodiments, the antenna elements 1112, 1114, 1116, and 1118 may include the illustrated cone shaped feed points.

FIGS. 13 and 14 illustrate antenna coupling. Referring to FIG. 13, antenna elements 1312 and 1314 may be in close distance to one another, such as from one-tenth to one-twentieth of the wavelength (λ/10 to λ/20), between adjacent edges of antenna elements 1312 and 1314. The antenna aperture may be increased by increasing the dimensions and/or the length of the antenna elements 1312 and 1314 by having the edges of, for example, the antenna elements 212, 214, 216, 218 of FIG. 3 form a meander pattern and/or tooth-line shape that increases the length of the edge. This shape may control the radiation coupling between adjacent antenna elements 1312 and 1314 by increasing the coupling area. Referring to FIG. 14, antenna 1400 may include a parasitic patch 1420 to increase coupling between antenna elements 1412 and 1414. Parasitic patch 1420 may be in a same layer between antenna elements 1412 and 1414 or parasitic patch 1420 may be in a different layer. Parasitic patch 1420 may overlap one or more of antenna elements 1412 and 1414 or non-overlapping antenna elements 1412 and 1414. It will be understood that various methods may be used to improve radiation coupling between antenna elements, such as in the non-limiting examples of FIGS. 13 and 14. Although the embodiments related to FIGS. 13 and 14 are described with respect to the 2×2 array antenna of FIG. 3, these embodiments may be related to any configuration of array antennas, such as 1×4, 3×3, 1×8, etc.

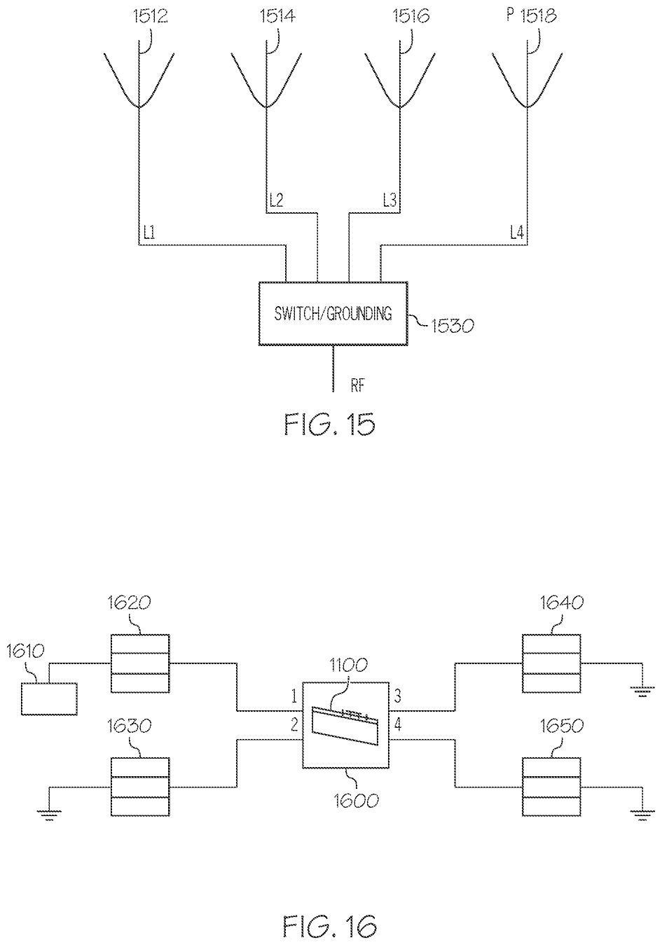

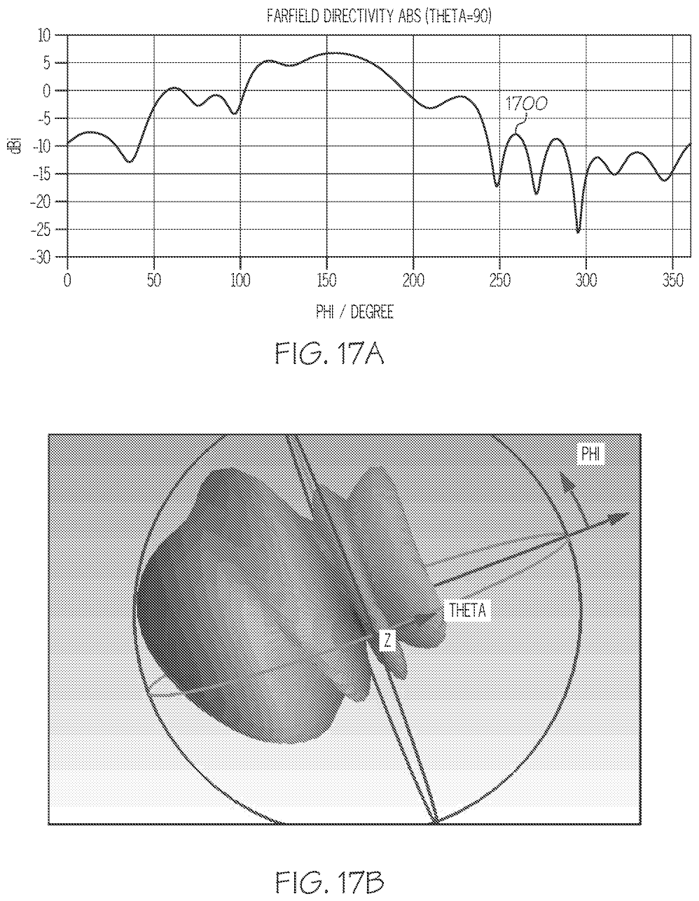

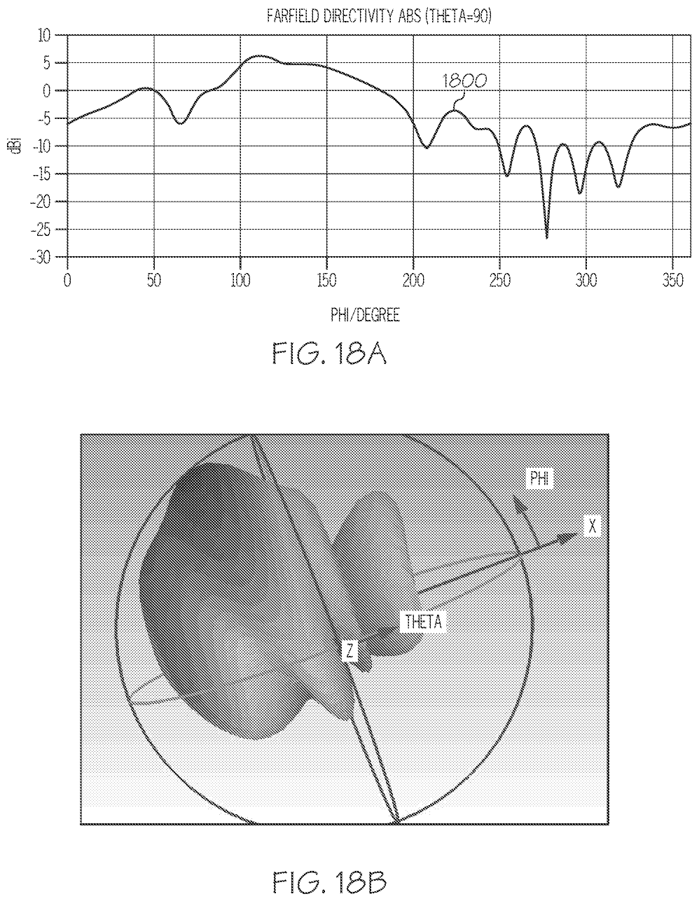

FIG. 15 illustrates a 1×4 linear array antenna, such as the antenna 1100 of FIG. 12. Referring to FIG. 15, antenna elements 1512, 1514, 1516, and 1518 are connected to a switch 1530 by lines L1, L2, L3, and L4, respectively. Due to the layout of the linear array antenna, lines L1, L2, L3, and L4 may have different lengths compared to one another. The different lengths may provide different phases for the signals received at antenna elements 1512, 1514, 1516, and 1518 to improve the shape of the beams formed by the 1×4 linear array antenna. FIG. 16 illustrates a switch for the 1×4 linear array antenna of FIG. 15. Referring to FIG. 16, switch 1600 may be connected to various ports of linear array antenna 1100. Each of the ports 1, 2, 3, and 4 of the switch 1600 may be coupled to different antenna elements, such as the antenna elements 1512, 1514, 1516, and 1518 of FIG. 15. The coupling to the different antenna elements may provide for feeding the antenna with different line lengths to compensate for the various phase delays. The different stripline lengths may provide different impedances for the passive antenna elements connected to ports 2, 3, and 4 and/or for the active antenna element connected to port 1. The various striplines may be used to adjust the phase differences between various antenna elements to improve the beam shape.

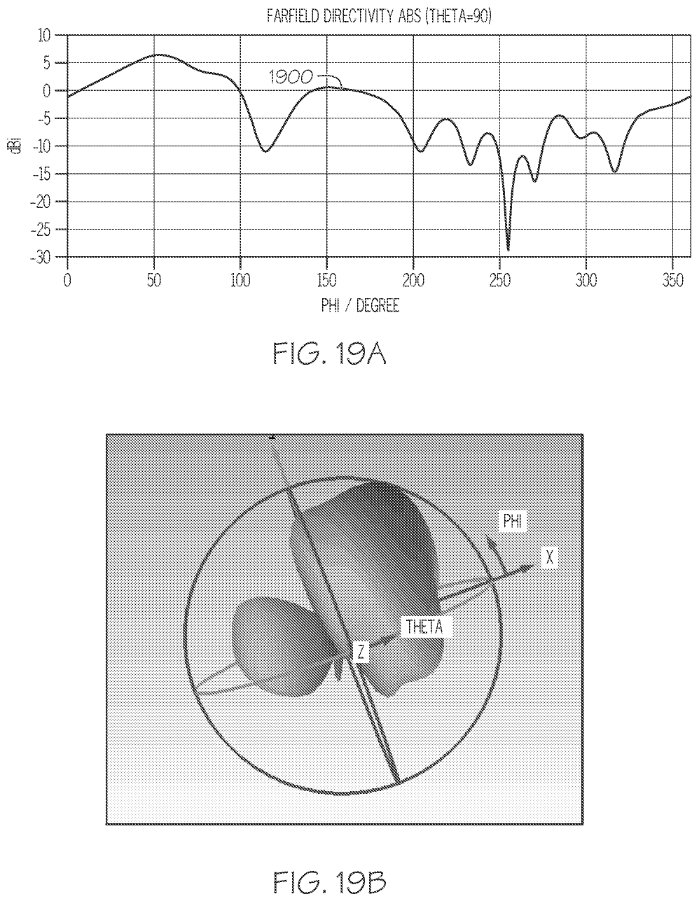

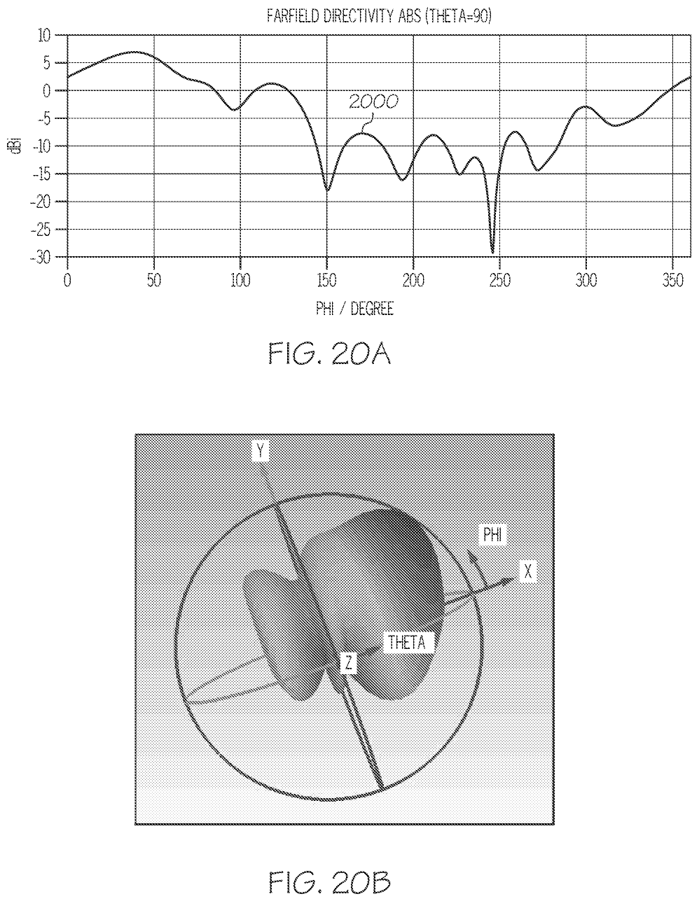

FIGS. 17A, 18A, 19A, and 20A graphically illustrate the direction of the beam forming from various antenna elements of the 1×4 linear array antenna of antenna elements 1112, 1114, 1116, and 1118, respectively, of FIG. 12. FIGS. 17B, 18B, 19B, and 20B illustrate the radiation pattern around a wireless electronic device, including the 1×4 linear array antenna of FIG. 15. As seen in FIGS. 17B, 18B, 19B, and 20B the antenna elements 1512, 1514, 1516, and 1518 of FIG. 15 produce beams in different directions based on the active antenna element. Furthermore, curves 1700, 1800, 1900, and 2000 provide a graphical illustration of the directivity of the beam from the antenna elements 1512, 1514, 1516, and 1518 of FIG. 15. Phi and theta are angles, respectively from the x-axis and the z-axis of the radiation pattern.

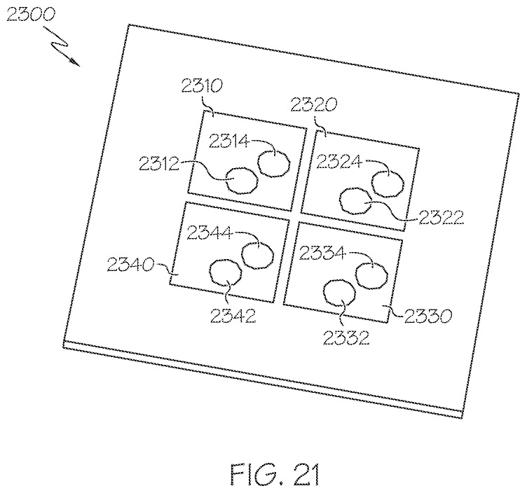

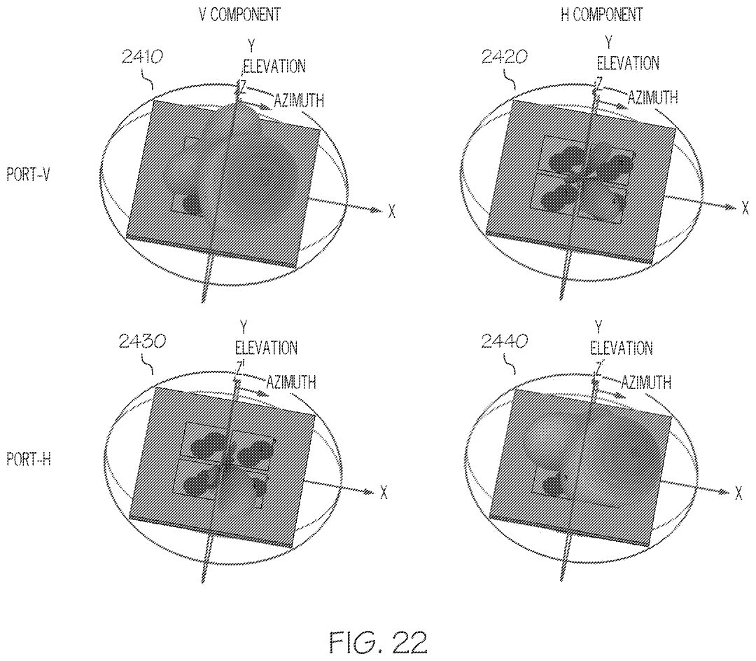

FIG. 21 illustrates a dual port realization of an array antenna. Referring to FIG. 21, antenna 2300 includes antenna elements 2310, 2320, 2330, and 2340. Each of the antenna elements 2310, 2320, 2330, and 2340 include two ports, such as ports 2312, 2314 for antenna element 2310, ports 2322, 2324 for antenna element 2320, ports 2332, 2334 for antenna element 2330, and ports 2342, 2344 for antenna element 2340. Dual polarization may be realized by exciting (i.e. putting in active mode) two ports associated with the same antenna element. The current for the two ports associated with the same antenna element may be orthogonal. The dual port design of antenna 2300 provides horizontal (H-component) and vertical (V-components) components whose radiation patterns have H or V direction excitation. FIG. 22 illustrates the radiation patterns around a wireless electronic device, including the dual port antenna of FIG. 21. Port 2322 of antenna element 2320 may be excited (i.e. active). If port 2322 is excited the radiation pattern 2410 of FIG. 24 shows a strong V-component and a radiation pattern 2420 with a small H-component. Similarly, if port 2314 of antenna element 2310 is excited, the radiation pattern 2440 of FIG. 24 shows a strong H-component and a radiation pattern 2430 with a small V-component. In other words, for this non-limiting example, port 2322 or port 2310 may be excited to obtain V-direction or H-direction excitation, respectively.

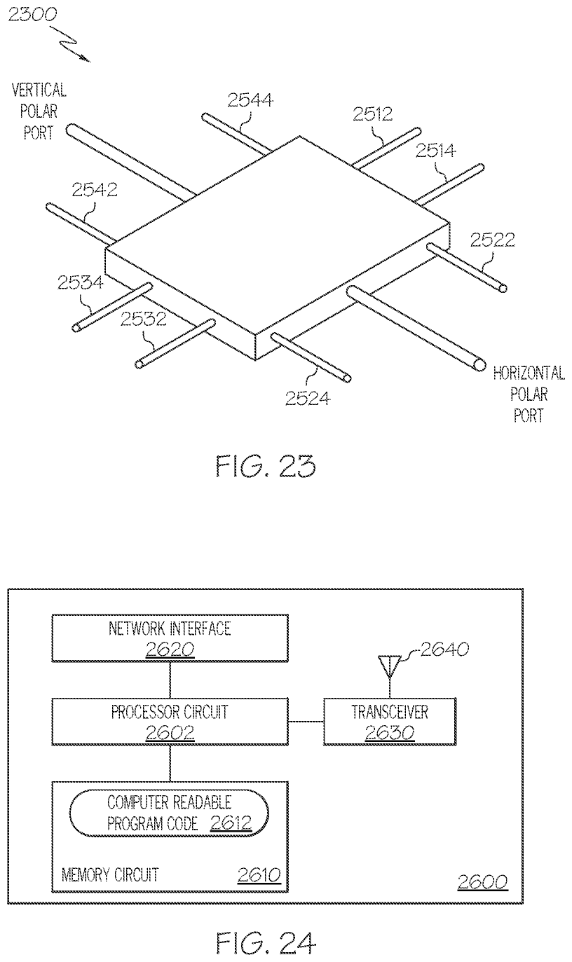

FIG. 23 illustrates a switch for the dual port antenna of FIG. 21. Dual port switch module 2300 has two RF ports for vertical and horizontal polarization of each antenna element. Thus dual port switch module 2300 has eight ports 2512, 2514, 2522, 2524, 2532, 2534, 2542, and 2544 that are associated with four antenna elements.

FIG. 24 is a block diagram of a wireless electronic device, including the antenna configurations of FIGS. 1, 3, 11, 15, and/or 21. Referring to FIG. 24, the wireless electronic device 2600 may include an antenna 2640 according to one or more embodiments described herein. The wireless electronic device 2600 includes a processor circuit 2602 and a memory circuit 1010 containing computer readable program code 2612. The processor circuit 2602 may include one or more data processing circuits, such as a general purpose and/or special purpose processor, e.g., microprocessor and/or digital signal processor, which may be collocated or distributed across one or more networks. The processor circuit 2602 may configured to execute the computer readable program code 2612 in the memory 2610 to perform at least some of the operations described herein as being performed by the wireless electronic device 2600. A network interface 2620 is coupled to the processor circuit 2602 and may communicate with a server or other external network entity, directly or indirectly. A transceiver 2630 may be coupled to the processor circuit 2602. An antenna 2640 may be coupled to the transceiver 2630 and may be configured according to one or more embodiments described herein. A wireless device, such as a mobile device may include an antenna module as described herein with compact size for use in mobile devices operating at mm Wave frequencies, impedance, and control of the electromagnetic field coupling to form the antenna beams to realize directional control of the beams (i.e. beam steering).

Various embodiments described herein provide an antenna system with compact size, control of the switching impedance and control of the electromagnetic field coupling to perform beam steering of the antenna beams to realize a high efficiency switch beam forming system. More specifically, reduced insertion loss by the switch is achieved by removing the feed network and/or microstrip feed lines from the antenna. The higher performance antenna is achieved by using a dual polar antenna using patch elements placed in closer proximity to one another than conventional antenna designs, without using an external feeding network. In other words, removing the external feeding network and/or microstrip feed lines reduces insertion losses of the antenna. Various embodiments described herein provide a radiation beam forming antenna system with wider bandwidth and a smaller array antenna module footprint than conventional antennas.

### Further Embodiments

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements, and elements should not be limited by these terms; rather, these terms are only used to distinguish one element from another element. Thus, a first element discussed could be termed a second element without departing from the scope of the present inventive concepts.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope.

1. An antenna module for beam steering at mm Wave frequencies, the antenna module comprising:
a plurality of antenna elements,
wherein the antenna module is configured to selectively activate a first antenna element of the plurality of antenna elements, while remaining ones of the plurality of antenna elements are passive, for beam steering in a first direction,
wherein the antenna module is further configured to selectively activate a second antenna element of the plurality of antenna elements, while the remaining ones of the plurality of antenna elements and the first antenna element are passive, for beam steering in a second direction, and
wherein the first antenna element and the second antenna element are respectively configured to resonate at a resonant frequency when activated.

2. The antenna module of claim 1, further comprising:
an antenna switch that is configured to selectively activate the first antenna element,
wherein the antenna switch is further configured to selectively activate the second antenna element.

3. The antenna module of claim 1,
wherein a distance between adjacent centers of the first antenna element and an adjacent antenna element is less than 0.25 times a wavelength of the resonant frequency.

4. The antenna module of claim 1
wherein a distance between adjacent edges of the first antenna element and an adjacent antenna element is less than 0.1 times a wavelength of the resonant frequency.

5. The antenna module of claim 2,
wherein the antenna switch is configured to ground or impedance terminate the remaining ones of the plurality of antenna elements that are passive.

6. The antenna module of claim 1,
wherein the remaining ones of the plurality of antenna elements that are passive are configured to determine the first direction of a first antenna beam radiating from the first antenna element.

7. The antenna module of claim 6,
wherein the first direction of the first antenna beam radiating from the first antenna element is controlled by a coupling level between the first antenna element and an adjacent antenna element.

8. The antenna module of claim 6,
wherein when a second antenna element of the remaining ones of the plurality of antenna elements is activated and the first antenna element is deactivated, a second antenna beam radiating from the second antenna element is generated, and
wherein the second antenna beam radiates in a second direction that is different from the first direction of the first antenna beam.

9. The antenna module of claim 1,
wherein the antenna module is absent of a feed network, a phase shifter, and a microstrip line to control a radiation pattern associated with the plurality of antenna elements.

10. The antenna module of claim 1,
wherein the plurality of antenna elements comprises four antenna elements that are arranged in a 2×2 array.

11. The antenna module of claim 1,
wherein the plurality of antenna elements comprises four antenna elements that are arranged in a 1×4 linear array.

12. The antenna module of claim 2,
wherein the antenna switch is configured to provide impedance loading to the first antenna element that is active, and
wherein the antenna switch is configured to either ground or provide impedance loading to remaining ones of the plurality of antenna elements that are configured to be passive to control a first direction of a first antenna beam radiating from the first antenna element.

13. The antenna module of claim 1,
wherein the first antenna element comprises a first port and a second port that are configured to activate the first antenna element,
wherein the first antenna element is configured to resonate at a first polarization when the first port is activated and is configured to resonate at a second polarization when the second port is activated, and
wherein the first polarization is orthogonal to the second polarization.

14. The antenna module of claim 13, wherein the first antenna element resonates in a dual polarization configuration when both the first port and the second port are activated.

15. The antenna module of claim 13,
wherein the first antenna element is configured to produce a first antenna beam in a first direction and with a first polarization when the first port is activated and the second port is deactivated, and is configured to produce the first antenna beam in the first direction and with a second polarization when the second port is activated and the first port is deactivated, and is configured to produce a third antenna beam in the first direction and with a third polarization when both the first port and the second port are activated, and
wherein the first, second, and third polarizations are different from one another.

16. The antenna module of claim 12,
wherein the remaining ones of the plurality of antenna elements comprise respective first ports and respective second ports, and
wherein the respective first ports and the respective second ports of the remaining ones of the plurality of antenna elements are configured to be passive when the first port and/or the second port of the first antenna element are activate.

17. An antenna system comprising:
a plurality of antenna elements; and
an antenna switch that is configured to selectively activate a first antenna element of the plurality of antenna elements, while remaining ones of the plurality of antenna elements are passive, for beam steering in a first direction,
wherein the antenna switch is further configured to selectively activate a second antenna element of the plurality of antenna elements, while the remaining ones of the plurality of antenna elements and the first antenna element are passive, for beam steering in a second direction, and
wherein the first antenna element and the second antenna element are respectively configured to resonate at a resonant frequency when activated.

18. A wireless device comprising the antenna system of claim 17.
